(19) United States
(12) Patent Application Publication
(10) Pub. No.: US 2025/0116283 A1
(43) Pub. Date: Apr. 10, 2025

(54) Clip and Clip Assembly

(71) Applicant: YKK Corporation, Tokyo (JP)

(72) Inventors: Satoshi Nakada, Macon, GA (US); Eric Chew, Macon, GA (US); Mariano Cuerda, Novi, MI (US); Tsutomu Yamada, Novi, MI (US); Evan Fegan, Macon, GA (US); Cole Bentley, Macon, GA (US)

(21) Appl. No.: 18/834,273

(22) PCT Filed: Jan. 16, 2023
(86) PCT No.: PCT/JP2023/001059

§ 371 Date: Jul. 30, 2024

Related U.S. Application Data
(60) Provisional application No. 63/305,130, filed on Jan. 31, 2022.

(51) Int. Cl. F16B 2/22; F16B 21/08

(52) U.S. Cl. CPC F16B 2/22; F16B 21/086

(57) ABSTRACT

A clip includes a clip body, a first side wing, and a second side wing. The clip body includes a top end, a bottom end, a front end, a rear end, a first side, and a second side. The top end, the bottom end, the first side, and the second side define a receiving region, and the top end defines an opening to the receiving region. The first side wing includes a first wing base proximate to the top end and extending outward from the first side. The second side wing includes a second wing base proximate to the top end and extending outward from the second side.

### TECHNICAL FIELD

The present invention relates to a clip and a clip assembly.

### BACKGROUND ART

Clips have been used for attaching a covering material to a base material. For example, a foam device, such as a cushion for an automobile seat furniture or the like, may include a clip having a base that is retained within the cushion and an engagement portion for engaging a seat cover and firmly locking the seat cover onto the cushion. While traditional clips can secure seat covers to cushions, they are difficult to detach after the initial engagement, thereby making it difficult to further modify and/or service the seat covers (for example, to replace a seat cover from old to new, to remove wrinkles on the seat cover, and to address modifications and/or misalignment of the seat cover). The traditional clips may also be unsuitable for particular cushion designs (for example, thin cushions) because they are too thick and can create discomfort if a user applies pressure to the cushion region with such clips. Furthermore, if a particular product requires a plurality of clips for attachment of the covering material, the traditional clips require an operator to individually set each clip in the base material.

### SUMMARY OF INVENTION

### Solution to Problem

The terms “invention”, “this invention”, and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the present invention covered by this patent are defined by the claims below, not this summary. This summary is a high-level overview of various embodiments of the present invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a clip includes a clip body, a first side wing, and a second side wing. The clip body includes a top end, a bottom end, a front end, a rear end, a first side, and a second side. The top end, the bottom end, the first side, and the second side define a receiving region of the clip, and the top end defines an opening to the receiving region. The first side wing includes a first wing base proximate to the top end and extending outward from the first side, and the second side wing includes a second wing base proximate to the top end and extending outward from the second side. In certain embodiments, at least the first side wing includes an aperture defined in the first wing base between an outer edge of the first wing base and the clip body.

According to various embodiments, a clip includes a clip body with a top end, a bottom end, a front end, a rear end, a first side, and a second side. The top end, the bottom end, the first side, and the second side define a receiving region, and the top end defines an opening to the receiving region. In some embodiments, the first side and the second side each extend obliquely from the bottom end. The clip also includes a first side wing with a first wing base proximate to the top end and extending outward from the first side and a second side wing with a second wing base proximate to the top end and extending outward from the second side.

In some embodiments, the clip freely includes a plurality of first side wings and/or a plurality of second side wings. In such embodiments, each of the first side wing may be independent from and/or not directly attached to other first side wings of the plurality of first side wings, and/or each second side wing may be independent from and/or not directly attached to other second side wings of the plurality of second side wings.

In various embodiments, the clip body freely defines an aperture between the front end and the rear end. In such embodiments, the aperture may be defined by at least one of the bottom end, the first side between the top end and the bottom end, and/or the second side between the top end and the bottom end.

In certain embodiments, the clip body freely defines an aperture at the top end configured to receive a detachment tool.

In some embodiments, the first side and/or the second side of the clip body freely defines a slit between the front end and the rear end of the clip body.

In any certain embodiments, the first wing further includes a lower anchoring protrusion extending downward from the outer edge of the first wing base.

In various embodiments, the first wing freely includes a connecting portion that connects the first wing base to the front end of the clip body.

In certain embodiments, the receiving region of the clip is located below the wing bases of the side wings. In such embodiments, when the clip is provided in a base material such as, but not limited to a foam, the wing bases may be embedded inside the base material to help secure the clip within the foam even if the bottom of the clip may get out of the foam in some spots or specific locations.

In various embodiments, a clip assembly includes a plurality of clips, and the adjacent clips may be connected by a connecting piece. In certain embodiments, the connecting piece may connect receiving regions of the adjacent clips of the clip assembly.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages are included within the present disclosure and protected by the accompanying claims.

The features and components of the following drawings are illustrated to emphasize the general principles of the present disclosure. Corresponding features and components throughout the drawings can be designated by matching reference characters for the sake of consistency and clarity.

### BRIEF DESCRIPTION OF DRAWINGS

FIG. 1 is an end view of a clip according to embodiments of the present disclosure in which a seat cover is attached to a seat foam portion.

FIG. 2 is an end view of the clip of FIG. 1.

FIG. 3 is a perspective view of a clip assembly with a plurality of clips of FIG. 1.

FIG. 4 is a top view of the clip assembly of FIG. 3.

FIG. 5 illustrates the clip of FIG. 1 with a detachment device.

FIG. 6 is an end view of a clip according to embodiments of the present disclosure.

FIG. 7 is a perspective view of a clip assembly with a plurality of clips of FIG. 6.

FIG. 8 is a perspective view of a clip according to embodiments of the present disclosure.

FIG. 9 is an end view of the clip of FIG. 8.

FIG. 10 is a top view of the clip of FIG. 8.

FIG. 11 is a perspective view of a clip according to embodiments of the present disclosure.

FIG. 12 is a perspective view of a clip according to embodiments of the present disclosure.

FIG. 13 is a perspective view of a clip according to embodiments of the present disclosure.

FIG. 14 is a perspective view of a clip assembly with a plurality of clips according to embodiments of the present disclosure.

FIG. 15 is a perspective view of a portion of a clip according to embodiments of the present disclosure.

FIG. 16 is a top view of the portion of the clip of FIG. 15.

FIG. 17 illustrates the portion of the clip of FIG. 15 with a detachment device.

FIG. 18 is a perspective view of a clip according to embodiments of the present disclosure.

FIG. 19 is an end view of the clip of FIG. 18.

FIG. 20 is a top view of the clip of FIG. 18.

FIG. 21 is an enlarged end view of the clip of FIGS. 18 to 20, and illustrates a state in which an attachment portion of a covering material is attached to the clip.

FIG. 22 is a perspective view of a clip according to embodiments of the present disclosure.

FIG. 23 is a top view of the clip of FIG. 22.

FIG. 24 is an end view of the clip of FIG. 22 as viewed in a front-rear direction.

FIG. 25 is an end view of the clip of FIG. 22 as viewed in a side-to-side direction.

FIG. 26 is a perspective view of a clip according to embodiments of the present disclosure.

FIG. 27 is a top view of the clip of FIG. 26, and illustrates a state in which the attachment portion 108 of the covering material 104 is engaged.

FIG. 28 is a cross-sectional view taken along line A-A of FIG. 27.

FIG. 29 is a perspective view of a clip according to embodiments of the present disclosure.

FIG. 30 is a top view of the clip of FIG. 29.

FIG. 31 is an end view of the clip of FIG. 29 as viewed in a front-rear direction.

FIG. 32 is an end view of the clip of FIG. 29 as viewed in a side-to-side direction.

FIG. 33 is a diagram illustrating a state in which the attachment portion is inserted parallel to an up-down direction toward the clip.

FIG. 34 is a diagram illustrating a state in which the attachment portion is inserted while being tilted with respect to the up-down direction toward the clip.

FIG. 35 is a diagram illustrating a state in which the attachment portion is continuously inserted from the state of FIG. 34.

FIG. 36 is a flowchart of a process of producing clips according to embodiments of the present disclosure.

### DESCRIPTION OF EMBODIMENTS

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Throughout the present disclosure, a reference numeral with a letter refers to a specific instance of an element and the reference numeral without an accompanying letter refers to the element generically or collectively. Therefore, as an example (not shown in the drawings), device “12A” refers to an instance of a device class, which may be referred to collectively as devices “12” and any one of which may be referred to generically as a device “12”. Directional references such as “up”, “down”, “top”, “bottom”, “left”, “right”, “front”, and “back”, among others, are intended to refer to the orientation as illustrated and described in the figure (or figures) to which the components and directions are referencing.

Described herein are clips for attaching a covering material to a base material. A clip according to embodiments of the present disclosure may be embedded in the base material and may selectively engage an attachment portion of the covering material. In certain embodiments, the clips described herein may allow selective detachment of the covering material from the base material. The clips described herein may have a reduced height as compared with the traditional clips and/or may be suitable for base materials having a reduced thickness as compared with the traditional clips. In some embodiments, the clips described herein may improve installation by allowing a plurality of clips to be installed in the base material and/or the clips to be installed in a non-linear arrangement. Various other benefits and advantages may be realized with systems and methods provided herein, and the above-described advantages should not be considered limiting.

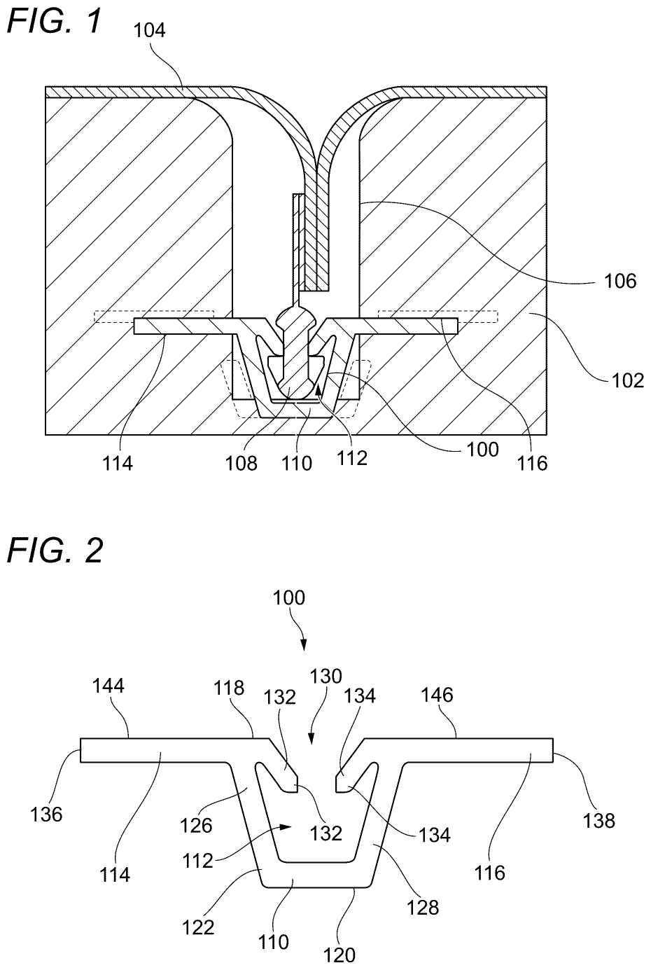

FIGS. 1 and 2 illustrate a clip 100 according to various embodiments. The clip 100 may be embedded into a base material 102. In the embodiment illustrated, the base material 102 is a seat foam portion forming a portion of a seat of a moving body such as a vehicle, airplane, train, and ship, forming a portion of furniture, and/or forming a portion of other base material as desired. A covering material 104 such as a seat cover may be attached to the base material 102 using the clip 100. In some non-limiting examples, the base material 102 may be a soft porous member and may be made of a plastic foam, for example, and the covering material 104 may be a flexible sheet including but not limited to a synthetic leather, a natural leather, and a fabric, for example. In other embodiments, other materials may be used to construct the base material 102 and/or the covering material 104. As some non-limiting examples, in other embodiments, the base material 102 and/or the covering material 104 may include different polymers and/or combinations of polymers including but not limited to polyurethane, polyester, and other polymers as desired.

As illustrated in FIG. 1, the clip 100 may be secured in the base material 102. In the embodiment illustrated, the clip 100 is provided at a bottom of a groove 106 formed in the base material 102. The particular groove 106 illustrated should not be considered limiting, and in other embodiments, the groove 106 may be omitted and the clip 100 may be secured in the base material 102 using other devices or mechanisms as desired. The covering material 104 is attached to the base material 102 by engaging an attachment portion 108 of the covering material 104 with the clip 100. The particular attachment portion 108 illustrated should not be considered limiting, and in other embodiments, the other mechanisms or devices suitable for engaging the clip 100 may be used as the attachment portion 108.

The clip 100 may be made of various materials as desired. In some non-limiting examples, the clip 100 is made of plastic including, but not limited to, polyethylene terephthalate (PET), polybutylene terephthalate (PBT), polypropylene (PP), polypropylene carbonate (PPC), acrylonitrile butadiene styrene (ABS), polycarbonate ABS (PC-ABS), polyacetal (POM), polyurethane (PUR), and combinations thereof, and/or various other materials or combinations of materials as desired.

Referring to FIG. 2, the clip 100 generally includes a clip body 110 that defines a receiving region 112. The clip 100 also includes at least one first side wing 114 and at least one second side wing 116 that extend in opposite directions from the clip body 110. In some embodiments, the clip 100 is symmetrical about a vertical axis as illustrated in FIG. 2; however, it need not be in other embodiments. As described in detail below, the covering material 104 may be attached to the base material 102 by engaging the attachment portion 108 with the receiving region 112 of the clip 100, and the side wings 114, 116 may facilitate attachment and securement of the clip 100 to the base material 102.

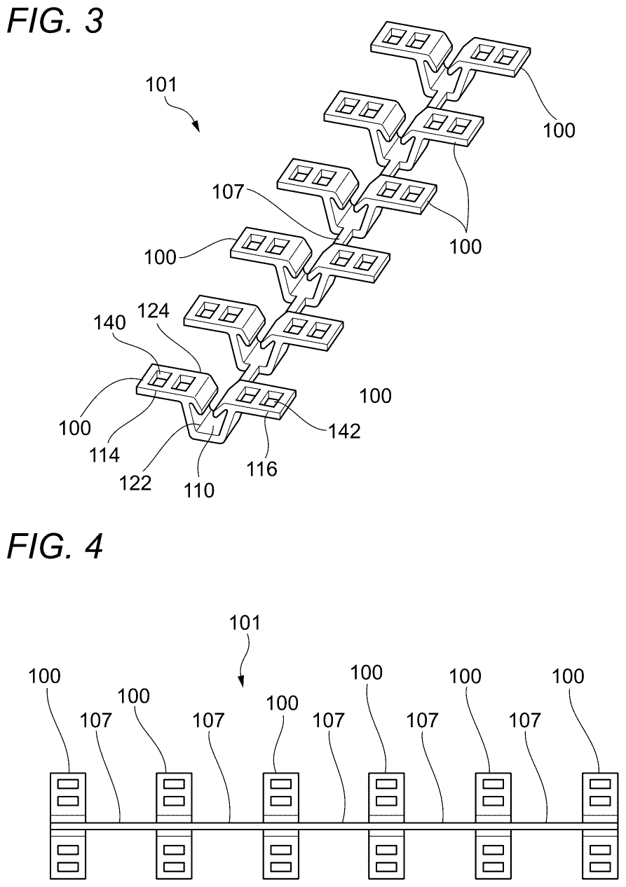

The clip body 110 of the clip 100 includes a top end 118, a bottom end 120 opposite to the top end 118, a front end 122, a rear end 124 (see FIG. 3) opposite to the front end 122, a first side 126, and a second side 128 opposite to the first side 126. In certain embodiments, the bottom end 120, the front end 122, the rear end 124, the first side 126, and the second side 128 cooperate to define the receiving region 112. The top end 118 may define an opening 130 for providing access to the receiving region 112 such that the attachment portion 108 of the covering material 104 may be inserted into the receiving region 112 through the opening 130. In some embodiments, as best illustrated in FIG. 2, a transverse dimension (for example, width) of the top end 118 of the clip body 110 may be different from that of the bottom end 120. In the embodiment illustrated, the width of the top end 118 is greater than the width of the bottom end 120, and the first and second sides 126, 128 extend away from the bottom end 120 such that the clip body 110 has a V shape. The first and second sides 126, 128 may extend away from the bottom end 120 at various angles as desired, including oblique angles, right angles, and the like. Therefore, while FIG. 2 illustrates the first and second sides 126, 128 extending obliquely away from the bottom end 120, in other embodiments, the first and second sides 126, 128 freely may be vertically above the bottom end 120. In other embodiments, the clip body 110 may have other shapes or profiles as desired.

Engagement features 132, 134 may extend from the first and second sides 126, 128 to the receiving region 112 so as to selectively engage the attachment portion 108 in the receiving region 112. In the embodiment illustrated, the engagement features 132, 134 are hooks, but a shape and a profile of the hooks should not be considered limiting, and in other embodiments, other features may be utilized as the engagement features 132, 134.

Referring to FIG. 2, the first side wing 114 extends outward from the first side 126 of the clip body 110 and the second side wing 116 extends outward from the second side 128 of the clip body 110. In the embodiment illustrated, the first side wing 114 and the second side wing 116 are each at the top end 118 of the clip body 110, and the first side wing 114 extends from the first side 126 at the top end 118, and the second side wing 116 similarly extends from the second side 128 at the top end 118. However, in other embodiments and as described in detail below, the side wings 114, 116 may extend from other locations of the clip body 110 as desired. In various embodiments, the side wings 114, 116 may be more proximate to the top end 118 than the bottom end 120 of the clip body 110. Such positioning of the side wings 114, 116 may facilitate attachment and use of the clip 100 in base materials 102 having various thicknesses, and may particularly facilitate attachment of the clip 100 in a base material 102 that is relatively thin. In one non-limiting example, the side wings 114, 116 more proximate to the top end 118 freely may allow for the use of the clips 100 in a base material having a thickness of less than 40 mm, such as less than 35 mm and less than 30 mm. In any embodiments, a height of the groove 106 (for example, from the top of the groove 106 to the bottom of the groove 106) is greater than 25 mm. In other embodiments, the thickness of the base material 102 and/or the height of the groove 106 may be various other dimensions as desired.

The first side wing 114 includes a wing base 144 having an outer edge 136, and the second side wing 116 similarly includes a wing base 146 having an outer edge 138. As illustrated in FIGS. 1 and 2, for example, the receiving region 112 is located below the wing bases 144, 146. While the wing bases 144, 146 are illustrated as generally planar in FIGS. 1 and 2, they need not be planar in other embodiments. A distance between the outer edges 136, 138 may be a greatest transverse dimension of the clip 100. Referring to FIG. 1, in various embodiments, a width of each wing base 144, 146 may be sufficient such that they are overlapped by a predetermined amount of the base material 102. Such overlap may allow the side wings 114, 116 to serve as an anchor or a stopper for the clip 100 in the base material 102.

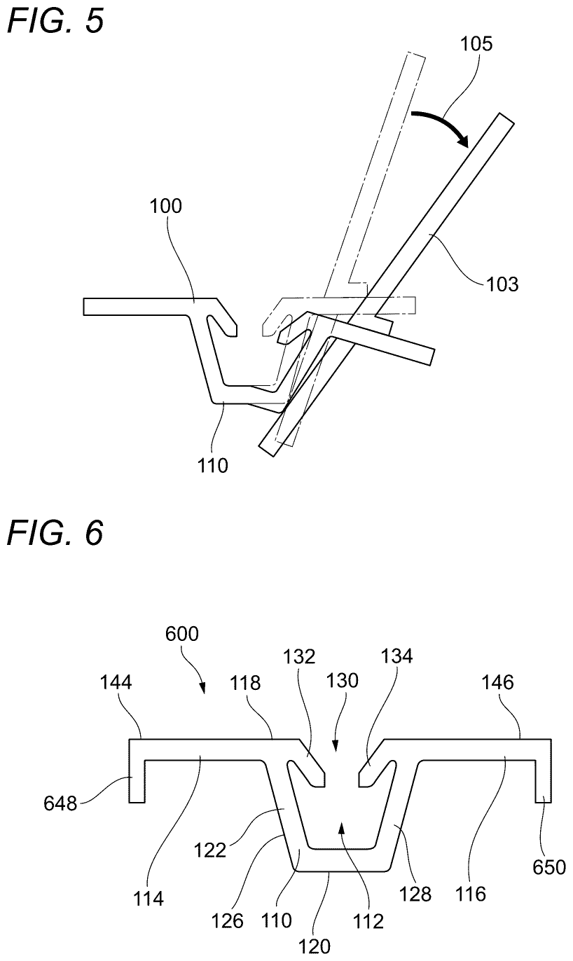

Referring to FIGS. 3 and 4, which illustrate a clip assembly 101 having a plurality of interconnected clips 100, in some embodiments, one or both of the side wings 114, 116 includes at least one aperture between the respective outer edges 136, 138 and the clip body 110. In the embodiment illustrated in FIGS. 3 and 4, the first side wing 114 of each clip 100 includes a plurality of first apertures 140 between the clip body 110 and the outer edge 136. The second side wing 116 similarly includes a plurality of second apertures 142 between the clip body 110 and the outer edge 138. The shape, size, and number of apertures 140, 142 should not be considered limiting on the present disclosure, and the shape, size, and number of first apertures 140 need not be the same as the second apertures 142. Moreover, when a clip assembly includes a plurality of clips, the number of apertures on each clip need not be the same. In certain embodiments, and as illustrated in FIG. 5, the apertures 140, 142 may selectively receive a disengagement tool 103 for facilitating disengagement of the clip 100 from the attachment portion 108. In particular, the disengagement tool 103 may be inserted into at least one of the apertures 140, 142 and tilted (indicated by an arrow 105). Such tilting may increase a distance between the engagement features 132, 134 such that the attachment portion 108 can be detached from the receiving region 112. The particular disengagement tool 103 illustrated should not be considered limiting on the present disclosure, and other suitable disengagement tools 103 may be utilized as desired.

As mentioned, in some embodiments, a single clip 100 or a plurality of clips 100 may be utilized with a base material 102. In embodiments in which a plurality of clips 100 is utilized, the clip assembly 101 may be freely utilized. As illustrated in FIGS. 3 and 4, the clip assembly 101 includes a plurality of clips 100, and the adjacent clips 100 are interconnected by a connecting piece 107. In certain embodiments, and as illustrated in FIGS. 3 and 4 for example, the connecting piece 107 may connect the receiving regions 112 of the adjacent clips 100. The connecting piece 107 freely may be monolithically or integrally formed with the clips 100. In certain embodiments, each connecting piece 107 connects adjacent bottom ends 120, although in other embodiments, the connecting piece 107 may connect other portions of the clips 100 as desired. In various embodiments, a width of the connecting piece 107 is less than the width of the bottom ends 120, which may facilitate bending of the clip assembly 101 in a side-to-side direction and enable installation of the clip assembly 101 in a non-linear arrangement as desired.

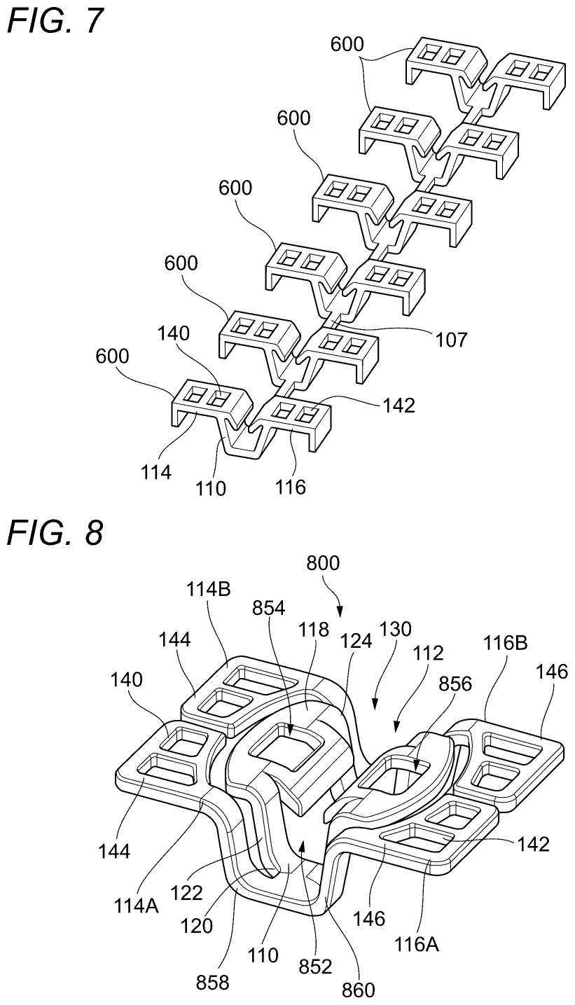

FIGS. 6 and 7 illustrate another example of clips 600 and a clip assembly 601 according to various embodiments. The clips 600 are substantially similar to the clips 100 (see FIGS. 1 to 5) except that each of the side wings 114, 116 further includes lower anchoring protrusions 648, 650 extending downward from the respective wing bases 144, 146. In some embodiments, the lower anchoring protrusions 648, 650 may further improve anchoring of the clips 600 within the base material 102. In certain embodiments, the lower anchoring protrusions 648, 650 may facilitate anchoring of the clip assembly 601 in a non-linear or curved arrangement. The lower anchoring protrusions 648, 650 in the illustrated example are formed to extend downward from the outer edges 136, 138 of the wing bases 144, 146, and formation positions thereof are not limited as long as they are formed to extend downward from the wing bases 144, 146, and the lower anchoring protrusions 648, 650 do not necessarily have to be formed on the outer edges 136, 138.

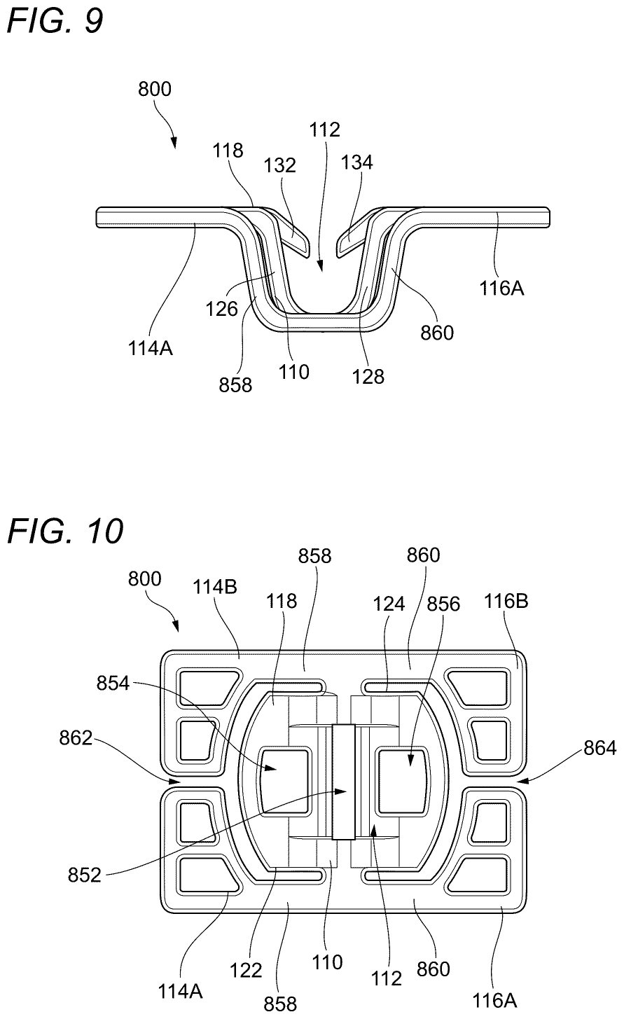

FIGS. 8 to 10 illustrate another example of a clip 800 according to various embodiments.

As compared with the clip 100 (see FIGS. 1 to 5), the clip body 110 of the clip 800 defines a bottom aperture 852 between the front end 122 and the rear end 124. In the embodiment illustrated, the bottom aperture 852 is defined by the bottom end 120, the first side 126, and the second side 128. However, in other embodiments, the bottom aperture 852 need not be defined by the bottom end 120, the first side 126, and the second side 128. As a non-limiting example, the bottom aperture 852 freely may only be in the bottom end 120, only in the first side 126, and/or only in the second side 128. When the bottom aperture 852 is provided, the bottom aperture 852 may facilitate construction of the clip 800. Furthermore, when the bottom aperture 852 is provided, flexibility of the clip 800 can be improved.

As best illustrated in FIGS. 8 and 10, as compared with the clip 100 (see FIGS. 1 to 5), the clip 800 additionally includes at least one aperture in the top end 118 for selectively receiving the disengagement tool 103 (for example, similar to the apertures 140, 142). In the embodiment illustrated, the clip 800 includes two apertures 854, 856. However, the number, shape, and location of apertures on the clip body 110 of the clip 800 should not be considered limiting.

As compared with the clip 100 (see FIGS. 1 to 5), the clip 800 includes a plurality of first side wings 114A to 114B and a plurality of second side wings 116A to 116B. In this embodiment and as best illustrated in FIG. 10, the side wings 114A to 114B each include a connecting portion 858 that connects the wing bases 144 to the clip body 110, and the side wings 116A to 116B each include a connecting portion 860 that connects the wing bases 146 to the clip body 110. As best illustrated in FIG. 10, as compared with the clip 100, the side wings 114A, 116A each extend from the front end 122 of the clip body 110, and the side wings 114B, 116B each extend from the rear end 124 of the clip body 110. In these embodiments, although the connecting portions 858, 860 extend from the front end 122 and the rear end 124 of the clip body 110, the wing bases 144, 146 are still more proximate to the top end 118 than the bottom end 120 of the clip body 110.

In certain embodiments and as best illustrated in FIG. 10, a gap 862 is defined between the first side wings 114A to 114B, and the first side wings 114A to 114B are not directly interconnected. Similarly, a gap 864 is defined between the second side wings 116A to 116B, and the second side wings 116A to 116B are not directly interconnected. In this embodiment, the side wings 114A to 114B and the side wings 116A to 116B are independently attached to the clip body 110. Such independent attachment of the side wings may improve flexibility of the clip 800 and reduce a foreign body feeling and/or sitting discomfort to a user when the clip 800 is provided in the base material 102.

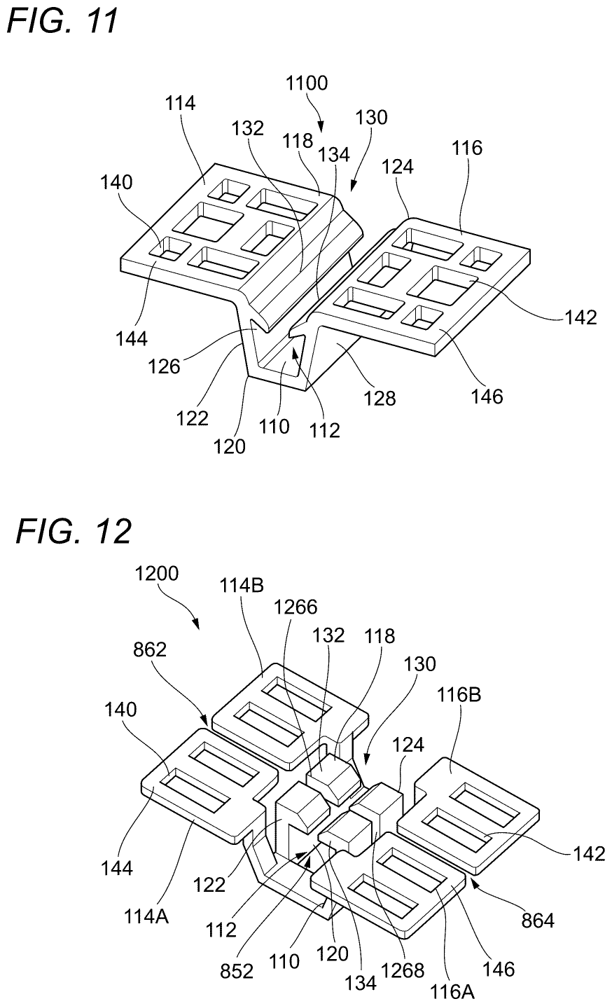

FIG. 11 illustrates another example of a clip 1100 according to various embodiments. The clip 1100 is substantially similar to the clip 100 (see FIGS. 1 to 5) except that the clip 1100 has an increased length, and the clip 1100 has more apertures 140, 142 that have different shapes and profiles as compared with the clip 100. In addition, as compared with the clip 100, the engagement features 132, 134 extend from the first and second sides 126, 128 between the top end 118 and the bottom end 120.

FIG. 12 illustrates another example of a clip 1200 according to embodiments. Similar to the clip 800 (see FIGS. 8 to 10), the clip 1200 includes a plurality of first side wings 114A to 114B and a plurality of second side wings 116A to 116B. However, as compared with the clip 800, a shape of the side wings 114, 116 and a shape of the apertures 140, 142 of the clip 1200 are different. As compared with the clip 800, the clip 1200 includes the bottom aperture 852 that is defined only in the bottom end 120 of the clip body 110. Further, the first side 126 and the second side 128 of the clip body 110 define slits 1266, 1268 between the front end 122 and the rear end 124 of the clip body 110. More specifically, as compared with the clip 800, the clip 1200 does not include the apertures 854, 856, and the clip 1200 further includes the slits 1266, 1268 (see portions surrounded by ellipses in FIG. 12) defined by the engagement features 132, 134 extending from the first and second sides 126, 128. In certain embodiments, the slits 1266, 1268 may improve flexibility and/or bendability of the clip 1200 in the side-to-side direction (for example, the clip 1200 has an improved ability to follow a curvature).

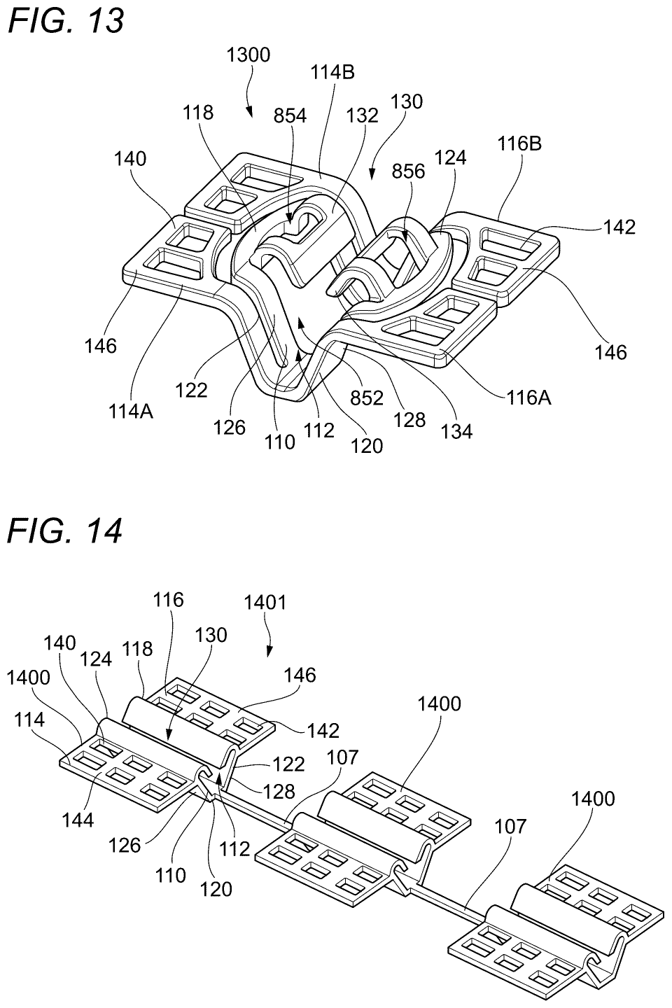

FIG. 13 illustrates another example of a clip 1300 according to embodiments. The clip 1300 is substantially similar to the clip 800 (see FIGS. 8 to 10) except that a portion of each of the engagement features 132, 134 of the clip 1300 extends partially above the top end 118 of the clip body 110.

FIG. 14 illustrates another clip assembly 1401 with a plurality of clips 1400 according to embodiments. The clip assembly 1401 with the clips 1400 is similar to the clip assembly 101 (see FIG. 3) with the clips 100 except that the clips 1400 include different shapes and numbers of the apertures 140, 142 as compared with the clips 100. In addition, a portion of each of the engagement features 132, 134 of each clip 1400 extends partially above the top end 118 of the clip body 110 as compared with the clip 100.

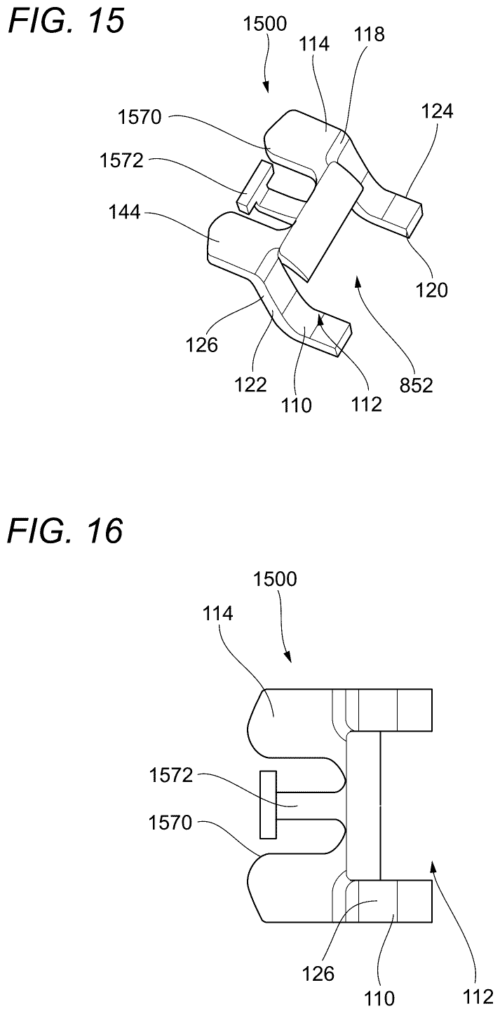

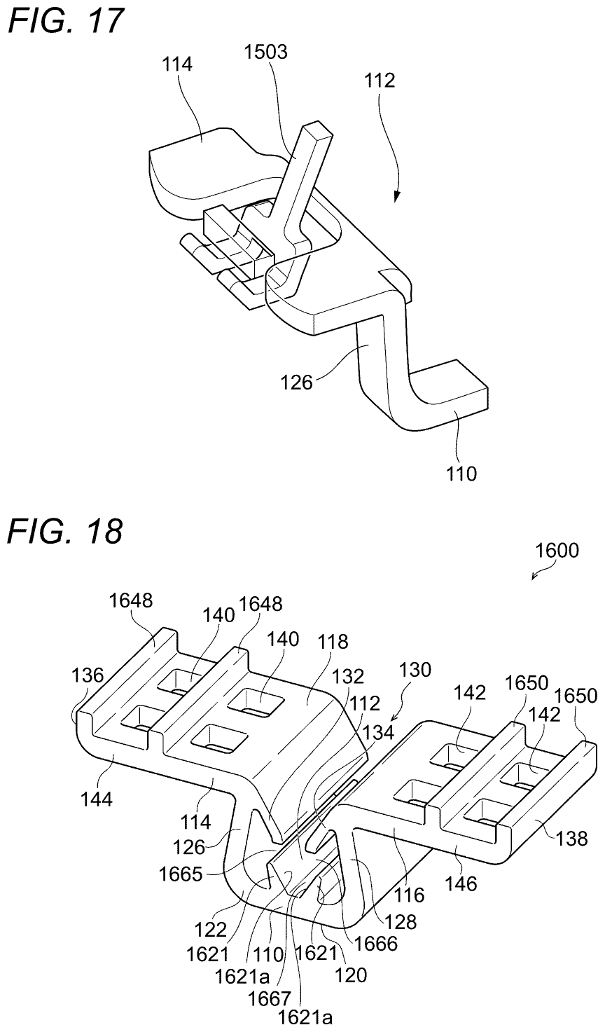

FIGS. 15 to 17 illustrate a portion of a clip 1500 according to embodiments. In particular, FIGS. 15 to 17 illustrate a portion of the bottom end 120, the first side 126, and the first side wing 114 of the clip 1500, with it being understood that the omitted second side 128 and second side wing 116 being a mirrored construction of the first side 126 and the first side wing 114. As illustrated in FIGS. 15 to 17, as compared with the clip 100 (see FIGS. 1 to 5), the clip 1500 omits the first aperture 140 in the first side wing 114, and the clip 1500 instead includes a cutout region 1570. The cutout region 1570 includes an engagement tab 1572 extending into the cutout region 1570. In certain embodiments, and as illustrated in FIG. 17, the engagement tab 1572 may facilitate engagement of a disengagement tool 1503 with the clip 1500 for selectively bending the clip 1500.

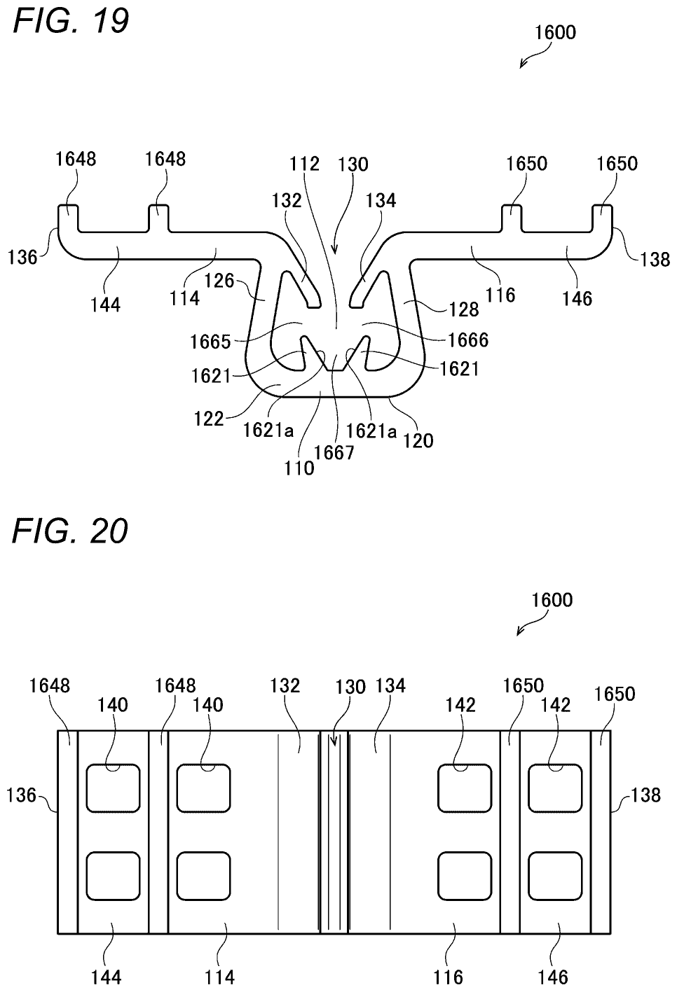

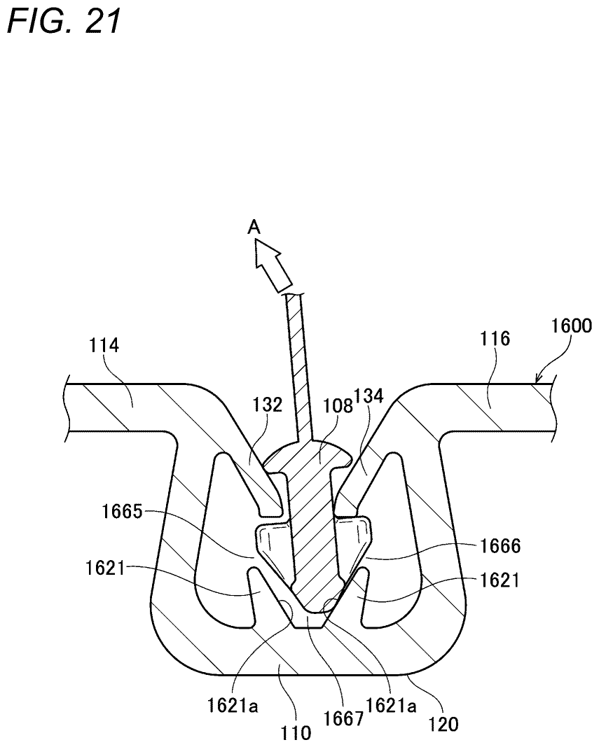

FIGS. 18 to 20 illustrate another example of a clip 1600 according to embodiments. FIG. 18 is a perspective view of the clip 1600 according to embodiments of the present disclosure. FIG. 19 is an end view of the clip 1600 of FIG. 18. FIG. 20 is a top view of the clip 1600 of FIG. 18. FIG. 21 is an enlarged end view of the clip 1600 of FIGS. 18 to 20, and illustrates a state in which the attachment portion 108 of the covering material 104 is attached to the clip 1600.

The clip 1600 is substantially similar to the clip 100 (see FIGS. 1 to 5) except that (i) the side wings 114, 116 further include upper anchoring protrusions 1648, 1650 extending upward from the wing bases 144, 146, (ii) the first and second sides 126, 128 extend obliquely closer to each other as they extends upward from the bottom end 120, and (iii) the clip 1600 includes a pair of protrusions 1621, 1621 extending from the bottom end 120 of the clip body 110 toward the receiving region 112.

With reference to the above-described (i), in some embodiments, the upper anchoring protrusions 1648, 1650 may further improve anchoring of the clips 600 within the base material 102. The upper anchoring protrusions 1648, 1650 in the illustrated example extend upward from four locations, that is, the outer edges 136, 138 of the wing bases 144, 146 and intermediate portions (substantially central portions) between the outer edges 136, 138 and the first and second sides 126, 128. However, formation positions and the number of the upper anchoring protrusions 1648, 1650 are not limited as long as the upper anchoring protrusions 1648, 1650 are formed to extend upward from the wing bases 144, 146. In addition to the upper anchoring protrusions 1648, 1650, the side wings 114, 116 may include the lower anchoring protrusions 648, 650 (see FIGS. 6 and 7) respectively extending downward from the wing bases 144, 146.

The first aperture 140 is divided into two front and rear parts and disposed between the pair of upper anchoring protrusions 1648, 1648 formed on the wing base 144. In addition, the first aperture 140 is divided into two front and rear parts and disposed between the first side 126 and the upper anchoring protrusion 1648 adjacent to the first side 126.

The second aperture 142 is divided into two front and rear parts and disposed between the pair of upper anchoring protrusions 1650, 1650 formed on the wing base 146. In addition, the second aperture 142 is divided into two front and rear parts and disposed between the second side 128 and the upper anchoring protrusion 1650 adjacent to the second side 128.

With reference to the above-described (ii), the first and second sides 126, 128 are tilted inward as they extends upward from the bottom end 120. Accordingly, a distance between the top ends is less than a distance between the bottom ends of the first and second sides 126, 128. Therefore, the receiving region 112 defined between the first and second sides 126, 128 is also formed to be narrowed from the lower side toward the upper side.

By adopting such a configuration, even when a downward force is applied to the first and second side wings 114, 116, the first and second sides 126, 128 are less likely to be opened in a direction away from each other (left-right outer direction in FIG. 19), and thus the engagement features 132, 134 are less likely to be opened. Accordingly, the engagement of the attachment portion 108 of the covering material 104 (see FIG. 1) with the receiving region 112 can be more stably maintained.

With reference to the above-described (iii), the pair of protrusions 1621, 1621 are formed over the entire length of the bottom end 120 of the clip body 110 in the front-rear direction. In addition, the pair of protrusions 1621, 1621 are disposed at positions facing the engagement features 132, 134 in an up-down direction via a first gap 1665 and a second gap 1666, respectively. Further, a third gap 1667 is provided between inner sides 1621a, 1621a of the pair of protrusions 1621, 1621. A shape of the third gap 1667 is a substantially triangular shape (substantially triangular prism shape) in cross-section so as to match a tip shape of the attachment portion 108 of the covering material 104 (see FIG. 21).

As illustrated in FIG. 21, the attachment portion 108 of the covering material 104 is accommodated in the first to third gaps 1665, 1666, and 1667 and can be engaged with the clip 1600. Both left and right side portions of the attachment portion 108 are accommodated in the first and second gaps 1665, 1666 and are located between the pair of protrusions 1621, 1621 and the engagement features 132, 134. Therefore, the clip 1600 is restricted from moving upward by the engagement features 132, 134 and prevented from coming off. The shape of the third gap 1667 matches the tip shape of the attachment portion 108 of the covering material 104, and a tip portion of the attachment portion 108 can be brought into contact with the inner sides 1621a, 1621a of the pair of protrusions 1621, 1621 and can be supported from both left and right sides. Therefore, a posture of the attachment portion 108 can be favorably maintained. In addition, for example, as indicated by an arrow A in FIG. 21, even when a tensile force directed obliquely upward is applied to the attachment portion 108, a holding strength of the attachment portion 108 can be favorably maintained.

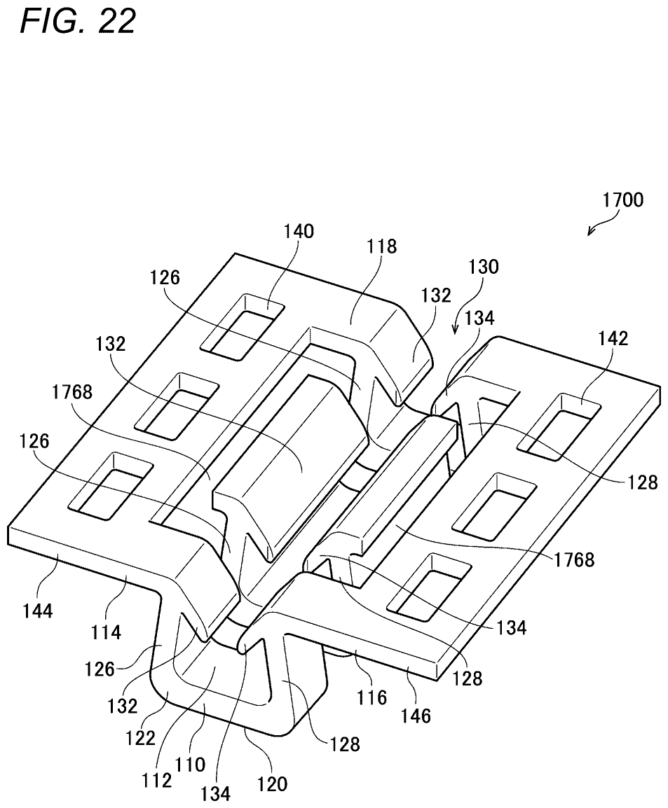

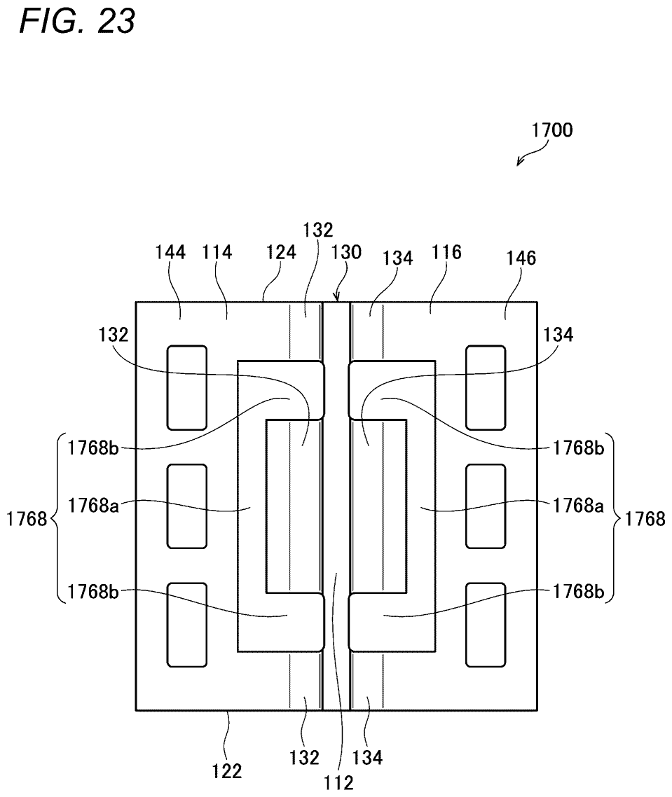

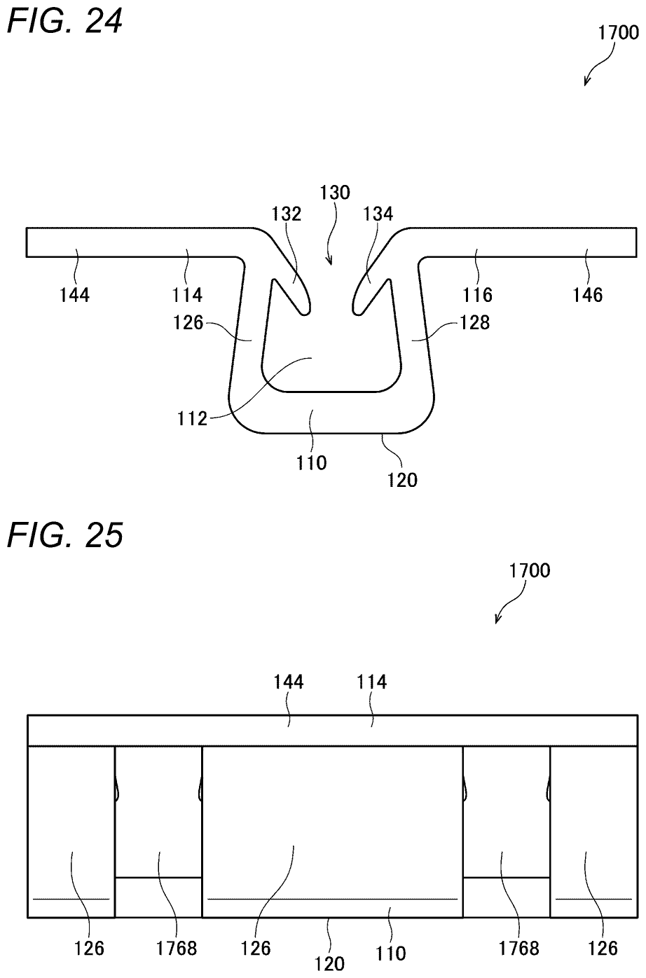

FIGS. 22 to 25 illustrate another example of a clip 1700 according to embodiments. FIG. 22 is a perspective view of the clip 1700 according to embodiments of the present disclosure. FIG. 23 is a top view of the clip 1700 of FIG. 22. FIG. 24 is an end view of the clip 1700 of FIG. 22 as viewed in a front-rear direction. FIG. 25 is an end view of the clip 1700 of FIG. 22 as viewed in the side-to-side direction.

The clip 1700 is substantially similar to the clip 100 (see FIGS. 1 to 5) except that each of the engagement features 132, 134 is divided into a plurality of parts in the front-rear direction.

In the clip 1700, in order to divide the engagement features 132, 134 into three parts in the front-rear direction, as illustrated in FIG. 23, a pair of substantially U-shaped gaps 1768, 1768 are spaced apart from each other in the side-to-side direction and face each other. The gap 1768 includes a front-rear direction extension portion 1768a extending in the front-rear direction, and a pair of side-to-side direction extension portions 1768b, 1768b extending in the side-to-side direction from both ends in the front-rear direction of the front-rear direction extension portion 1768a toward the receiving region 112. The pair of gaps 1768, 1768 divide the engagement features 132, 134 or the first and second sides 126, 128 connected to the engagement features 132, 134 into three parts in the front-rear direction.

In this way, one clip 1700 includes a plurality of (three in this example) independent engagement features 132, 134, and thus a tensile strength can be improved.

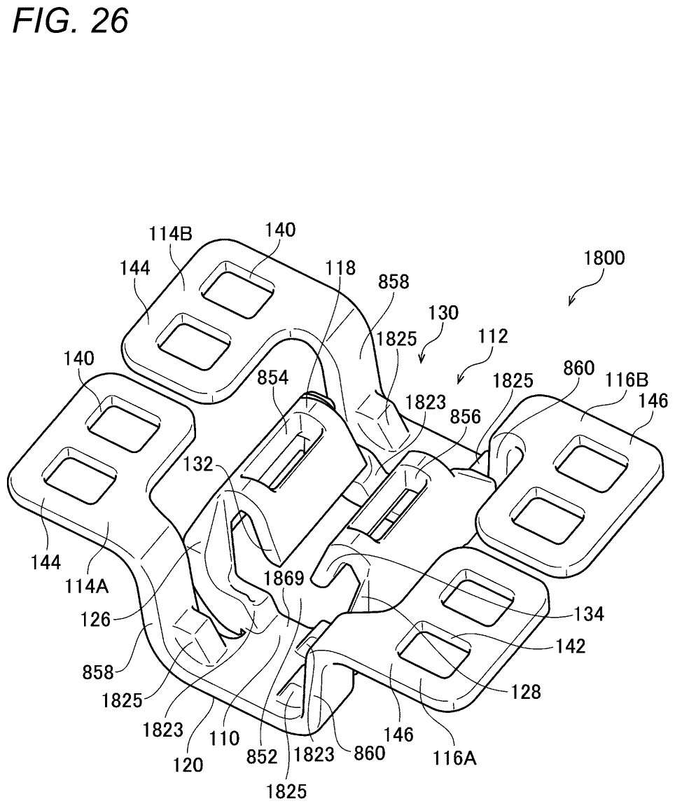

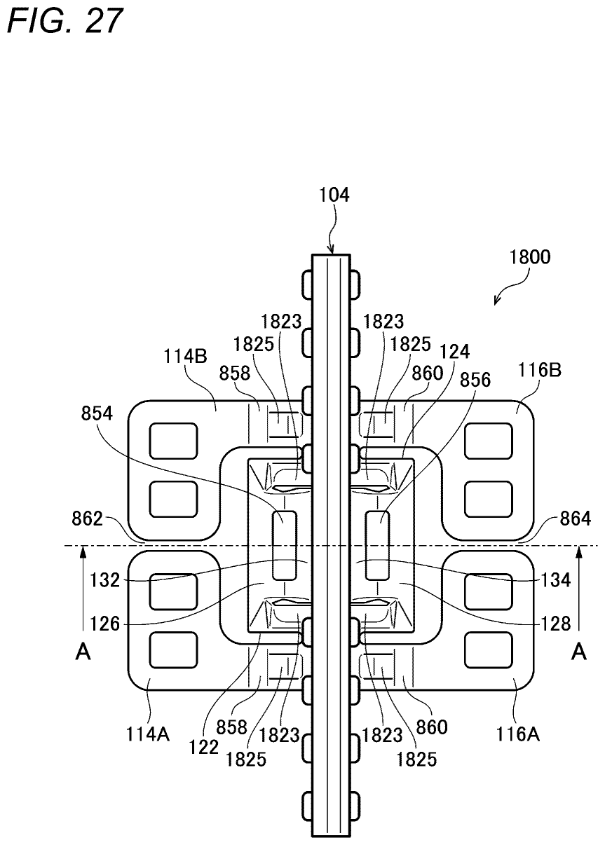

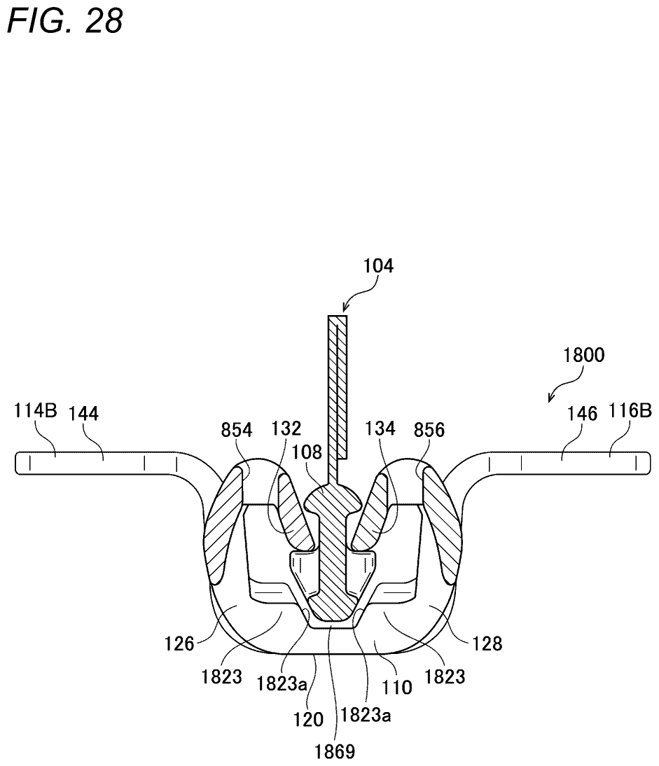

FIGS. 26 to 28 illustrate another example of a clip 1800 according to embodiments. FIG. 26 is a perspective view of the clip 1800 according to embodiments of the present disclosure. FIG. 27 is a top view of the clip 1800 of FIG. 26, and illustrates a state in which the attachment portion 108 of the covering material 104 is engaged. FIG. 28 is a cross-sectional view taken along line A-A of FIG. 27.

Similar to the clip 800 (see FIGS. 8 to 10), the clip 1800 includes a plurality of first side wings 114A to 114B and a plurality of second side wings 116A to 116B. However, the clip 1800 is different from the clip 800 in that protrusions 1823 protruding upward are provided at four connecting points between the first and second sides 126, 128 and the bottom end 120 of the clip body 110.

As illustrated in FIG. 28, a gap 1869 is provided between inner sides 1823a, 1823a of the pair of protrusions 1823, 1823 provided on a first side 126 side (left side in FIG. 28) and inner sides 1823a, 1823a of the pair of protrusions 1823, 1823 provided on a second side 128 side (right side in FIG. 28). A shape of the gap 1869 is a substantially triangular shape (substantially triangular prism shape) in cross-section so as to match the tip shape of the attachment portion 108 of the covering material 104.

As illustrated in FIG. 28, the attachment portion 108 of the covering material 104 is accommodated in the gap 1869 and can be engaged with the clip 1800. As described above, the shape of the gap 1869 matches the tip shape of the attachment portion 108 of the covering material 104, and thus the tip portion of the attachment portion 108 can be brought into contact with the inner sides 1823a, 1823a of the pair of protrusions 1823, 1823, and can be supported from both left and right sides. Therefore, a posture of the attachment portion 108 can be favorably maintained. In addition, even when tension is applied in any direction, the holding strength of the attachment portion 108 can be favorably maintained.

In addition, the clip 1800 is different from the clip 800 (FIGS. 8 to 10) in that ribs 1825 protruding upward are provided at four connecting points between the connecting portions 858, 860 and the bottom end 120 of the clip body 110. By providing such ribs 1825, even when a downward force is applied to the first and second side wings 114, 116, the first and second sides 126, 128 are less likely to be opened in a direction away from each other (left-right outer direction in FIG. 28), and thus the engagement features 132, 134 are less likely to be opened. Accordingly, the engagement of the attachment portion 108 of the covering material 104 with the receiving region 112 can be more stably maintained.

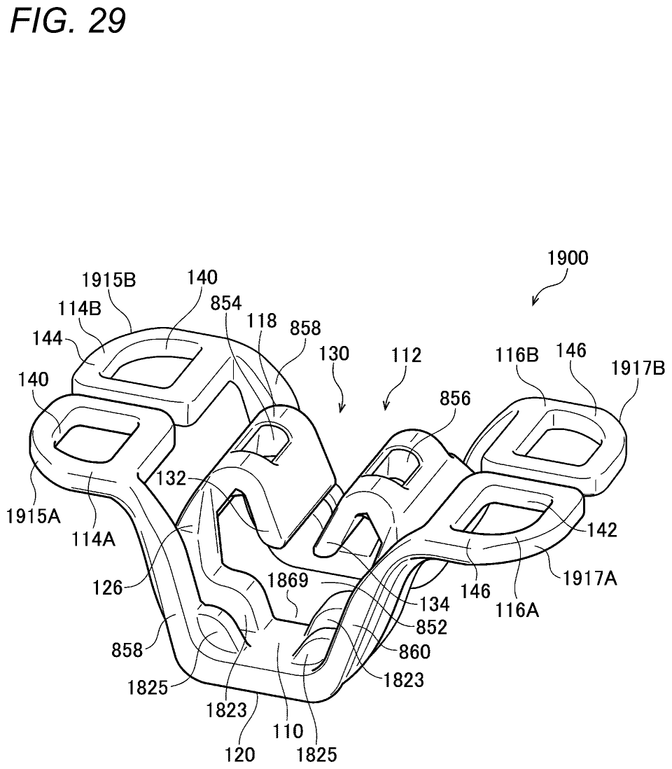

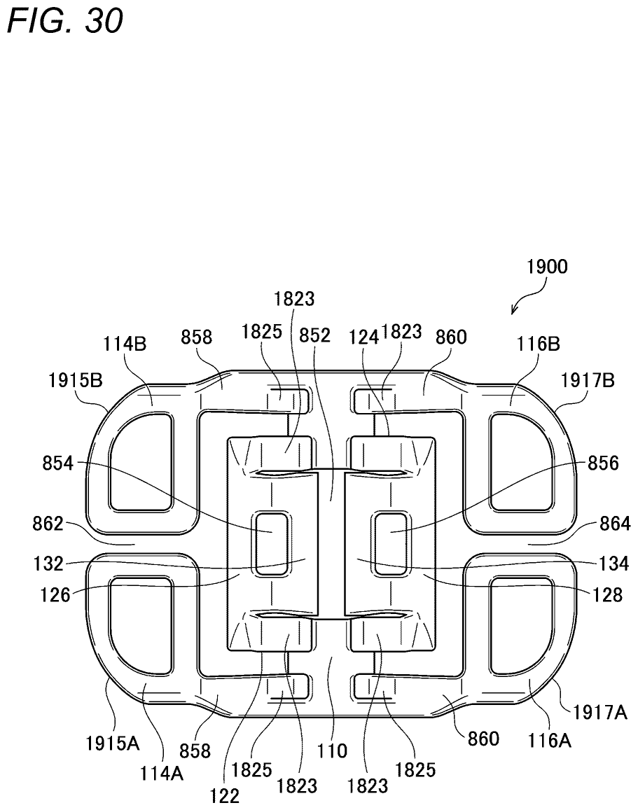

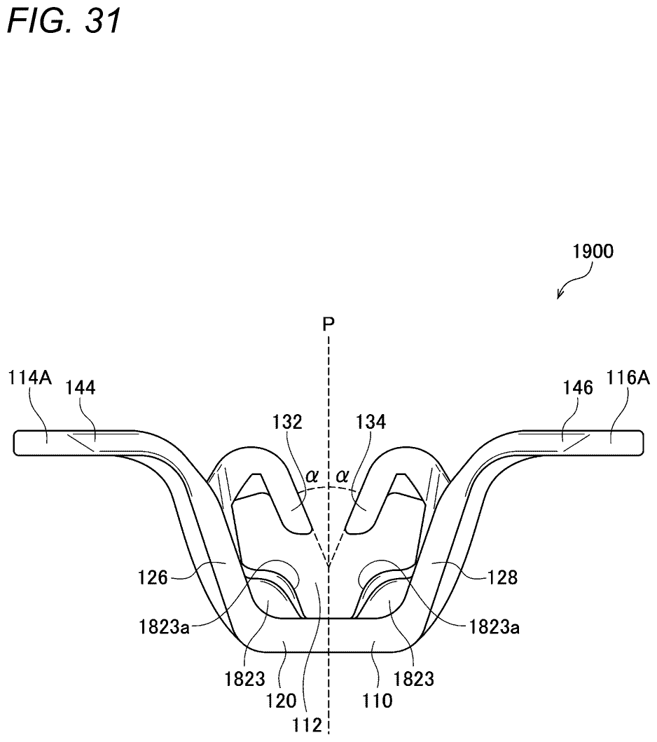

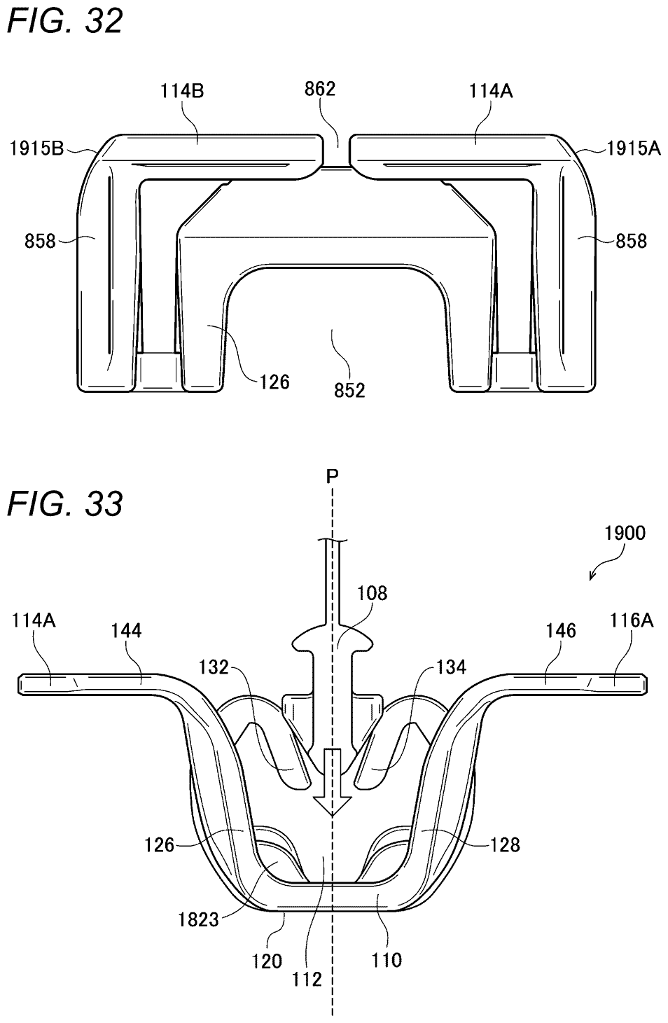

FIGS. 29 to 32 illustrate another example of a clip 1900 according to embodiments. FIG. 29 is a perspective view of the clip 1900 according to embodiments of the present disclosure. FIG. 30 is a top view of the clip 1900 of FIG. 29. FIG. 31 is an end view of the clip 1900 of FIG. 29 as viewed in the front-rear direction. FIG. 32 is an end view of the clip 1900 of FIG. 29 as viewed in the side-to-side direction.

The clip 1900 is substantially similar to the clip 1800 (see FIGS. 26 to 28) except that corner portions of the first and second side wings are relatively largely chamfered.

More specifically, of the pair of side wings 114A, 114B constituting the first side wing 114, a front corner portion 1915A of the front side wing 114A and a rear corner portion 1915B of the rear side wing 114B are largely chamfered as compared with the other embodiments. Similarly, of the pair of side wings 116A, 116B constituting the second side wing 116, a front corner portion 1917A of the front side wing 116A and a rear corner portion 1917B of the rear side wing 116B are largely chamfered as compared with the other embodiments. This improves comfort when the user gets in a cushion region at which the clip 1900 is located.

The clip body 110 of the clip 1900 defines the bottom aperture 852 between the front end 122 and the rear end 124 similar to the clip 800 (see FIGS. 8 to 10) or the clip 1800 (see FIGS. 26 to 28). In the embodiment illustrated, the bottom aperture 852 is defined by the bottom end 120, the first side 126, and the second side 128. When such a bottom aperture 852 is provided, the flow of a foaming agent is improved, and the clip 800 can be easily constructed. Furthermore, when the bottom aperture 852 is provided, flexibility of the clip 800 can be improved.

As illustrated in FIG. 31, an angle α formed by tip portions (free ends) of the engagement features 132, 134 and a plane P extending in the up-down direction is preferably 45° or less, more preferably 30° or less, and further preferably 25° or less. In this way, the engagement features 132, 134 are tilted toward the up-down direction than the front-rear direction or the side-to-side direction, and thus the attachment portion 108 of the covering material 104 can be guided toward the receiving region 112, and insertability of the attachment portion 108 can be improved.

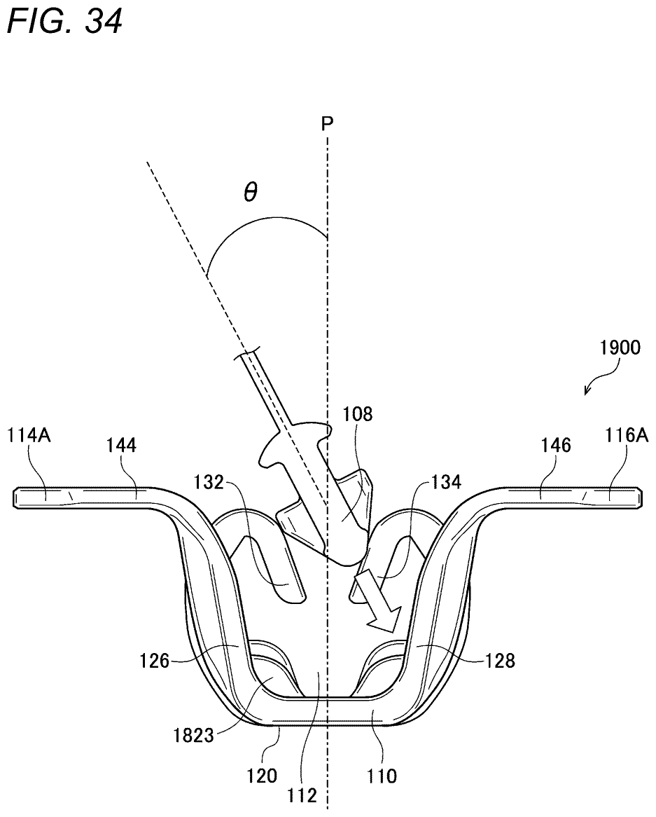

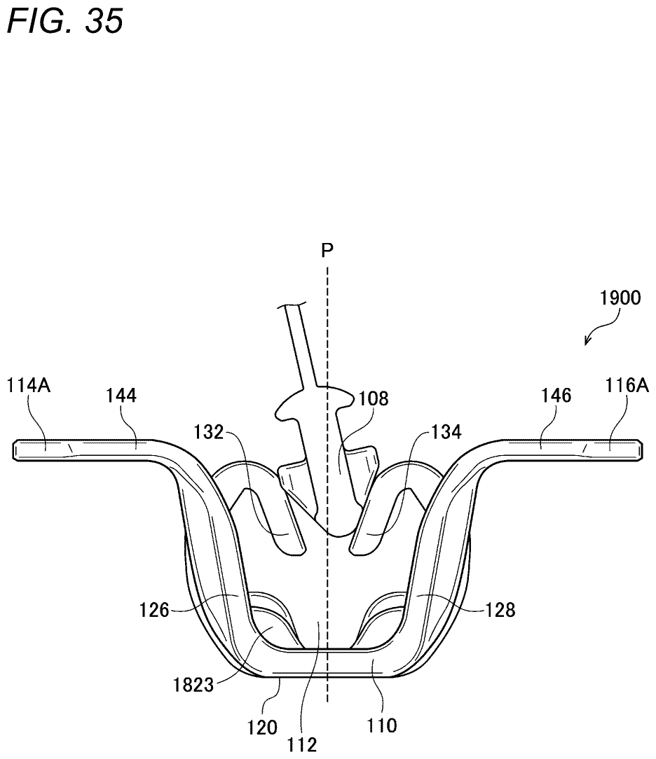

FIG. 33 is a diagram illustrating a state in which the attachment portion 108 is inserted parallel to the up-down direction toward the clip 1900. FIG. 34 is a diagram illustrating a state in which the attachment portion 108 is inserted while being tilted with respect to the up-down direction toward the clip 1900. FIG. 35 is a diagram illustrating a state in which the attachment portion 108 is continuously inserted from the state of FIG. 34.

As illustrated in FIG. 33, when the attachment portion 108 of the covering material 104 is inserted parallel to the up-down direction, the engagement features 132, 134 can be inserted into the receiving region 112 and engaged with the clip 1900 without any problem even if the engagement features 132, 134 are not tilted toward the up-down direction with the angle α as described above. However, as illustrated in FIG. 34, when the attachment portion 108 is inserted with an insertion angle θ tilted with respect to the up-down direction, if the engagement features 132, 134 are not tilted toward the up-down direction with the angle α as described above, the attachment portion 108 may slip on the engagement features 132, 134 and may not be engaged with the clip 1900. However, in the present embodiment, the engagement features 132, 134 are tilted toward the up-down direction with the angle α as described above, and thus when the attachment portion 108 is continuously inserted from the state of FIG. 34, the engagement features 132, 134 guide the attachment portion 108 of the covering material 104 toward the receiving region 112 as illustrated in FIG. 35, and the attachment portion 108 is reliably engaged with the clip 1900. The engagement features 132, 134 of the clip 1800 (see FIGS. 26 to 28) are also tilted toward the up-down direction than the front-rear direction or the side-to-side direction, and have the same functions and effects as the engagement features 132, 134 of the present embodiment.

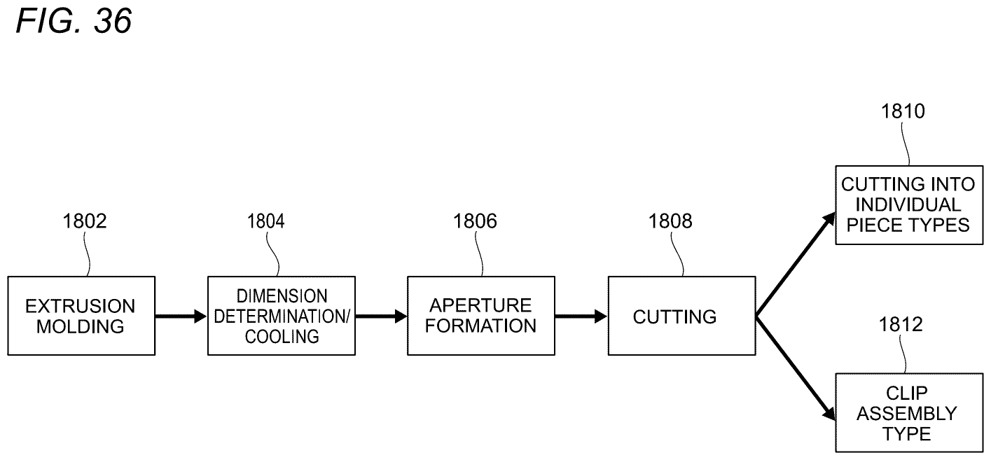

In certain embodiments, the clips described herein may be shaped so as to be adapted for mass production. This non-limiting feature will be described with reference to FIG. 36, which is a schematic flowchart illustrating a process of producing clips. While reference will be made to the clip 100, the follow process may be used to produce any clips of the present disclosure.

In a block 1802, the process may include extrusion molding of the clips 100. The extrusion molding may include supplying a resin material from a hopper to a heated cylinder, and melted resin may be extruded through a mold so that a molded article with one or more clips 100 is produced.

In a block 1804, following or at the same as the extrusion molding of the block 1802, the molded article with one or more clips 100 may be cooled. Various cooling methods can be adopted such as water-cooling or air-cooling.

In any block 1806, cutting of the side wings 114, 116 of the one or more clips 100 of the molded article is performed such that the apertures 140, 142 are formed in the side wings 114, 116. Cutting in the block 1806 may be performed using various cutting techniques as desired, including but not limited to punch-cutting techniques or rotary cut techniques.

In a block 1808, each the molded article is cut to that either a plurality of individual clips 100 are produced (block 1810) or the clip assembly 101 is produced with the plurality of interconnected clips 100 (block 1812). Any shearing machine or cutting machine can be used for cutting in the block 1808.

As described above, the clips described herein may be improved as compared with the traditional clips. As some non-limiting examples, the clips disclosed herein may be suitable for inclusion in a thin base material while minimizing potential discomfort to the user. The clips described herein may have improved flexibility and formability, and in certain embodiments, the clips may allow for installation of a plurality of interconnected clips in a non-linear arrangement. Such clips may reduce the number of operators and/or work needed to install a plurality of clips in a base material. The clips described herein may further allow for selective disengagement of the covering material from the base material, thereby improving repair, replacement, and/or other access as desired after an initial installation of the covering material with the base material. Additional benefits and advantages may be realized with the disclosed clips.

The above-described aspects are merely possible examples of implementations, merely set forth for a clear understanding of the principles of the present disclosure. Many variations or modifications can be made to the above-described embodiment(s) without departing substantially from the spirit and principles of the present disclosure. Moreover, features from the above-described various embodiments or examples may be combined as desired, and the above-described embodiments are not intended to be limiting. As a non-limiting example, the clip 800 (see FIGS. 8 to 10) may include the lower anchoring protrusions on the side wings as illustrated together with the clip 600 (see FIGS. 6 to 7). In this way, all modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described invention, nor the claims that follow.

The present application is based on U.S. Provisional Patent Application 63/305,130 filed on Jan. 31, 2022, the contents of which are incorporated herein by reference.

### REFERENCE SIGNS LIST

100, 600, 800, 1100, 1200, 1300, 1400, 1500, 1600, 1700, 1800, 1900: clip
101, 601, 1401: clip assembly
102: base material
103: disengagement tool
104: covering material
105: arrow
106: groove
107: connecting piece
108: attachment portion
110: clip body
112: receiving region
114, 114A, 114B: first side wing
116, 116A, 116B: second side wing
118: top end
120: bottom end
122: front end
124: rear end
126: first side
128: second side
130: opening
132, 134: engagement feature
136, 138: outer edge
140: first aperture
142: second aperture
144, 146: wing base
648, 650: lower anchoring protrusion
852: bottom aperture
854, 856: aperture
858, 860: connecting portion
862, 864: gap
1266, 1268: slit
1503: disengagement tool
1570: cutout region
1572: engagement tab
1621: protrusion
1621a: inner side
1648, 1650: upper anchoring protrusion
1665: first gap
1666: second gap
1667: third gap
1768: gap
1768a: front-rear direction extension portion
1768b, 1768b: side-to-side direction extension portion
1823: protrusion
1823a: inner side
1825: rib
1869: gap
1915A: front corner portion
1915B: rear corner portion
1917A: front corner portion
1917B: rear corner portion

1. A clip comprising:
a clip body including a top end, a bottom end, a front end, a rear end, a first side, and a second side, the top end, the bottom end, the first side, and the second side defining a receiving region, and the top end defining an opening to the receiving region;
a first side wing including a first wing base proximate to the top end and extending outward from the first side; and
a second side wing including a second wing base proximate to the top end and extending outward from the second side.

2. The clip according to claim 1, wherein
the first side wing at least includes an aperture defined in the first wing base between an outer edge of the first wing base and the clip body.

3. The clip according to claim 2, wherein
the receiving region is located below the first wing base and the second wing base.

4. The clip according to claim 1, wherein
the first and second side wings respectively include lower anchoring protrusions extending downward from the first and second wing bases and/or upper anchoring protrusions extending upward from the first and second wing bases.

5. The clip according to claim 1, wherein
the clip body includes an aperture (between the front end and the rear end and
the aperture (is defined by at least one of the bottom end, the first side, and the second side.

6. The clip according to claim 1, wherein
the clip body includes an aperture in the top end.

7. The clip according to claim 1, further comprising:
a plurality of the first side wings and a plurality of the second side wings.

8. The clip according to claim 7, wherein
a gap is defined between the plurality of first side wings, and the plurality of first side wings are not directly interconnected, and
a gap is defined between the plurality of second side wings, and the plurality of second side wings are not directly interconnected.

9. The clip according to claim 8, wherein
each of the plurality of first side wings includes a connecting portion that connects the first wing base to the clip body, and
each of the plurality of second side wings includes a connecting portion that connects the second wing base to the clip body.

10. The clip according to claim 1, wherein
the first side and/or the second side of the clip body defines a slit between the front end and the rear end of the clip body.

11. The clip according to claim 1, wherein
the first and second side wings include a cutout region, and
the cutout region includes an engagement tab extending into the cutout region.

12. The clip according to claim 1, wherein
the first and second sides extend closer to each other as the first and second sides extends upward from the bottom end.

13. The clip according to claim 1, further comprising:
engagement features extending from the first and second sides to the receiving region, respectively, wherein
the engagement features are divided into a plurality of parts.

14. The clip according to claim 1, wherein
protrusions are provided at connecting points between the first and second sides and the bottom end of the clip body.

15. The clip according to claim 9, wherein
ribs are provided at connecting points between the connecting portion and the bottom end of the clip body.

16. A clip assembly comprising:
a plurality of the interconnected clips according to claim 1.

17. The clip assembly according to claim 16, further comprising:
a connecting piece that interconnects the adjacent clips.

18. The clip assembly according to claim 17, wherein
the connecting piece connects receiving regions of the adjacent clips.
